(19) United States
(12) Patent Application Publication
(10) Pub. No.: US 2006/0209857 A1
(43) Pub. Date: Sep. 21, 2006

(54) Broadband home applications gateway/residential gateway systems, methods and computer program products

(75) Inventor: John Alson Hicks III, Roswell, GA (US)

Correspondence Address: MYERS BIGEL SIBLEY & SAJOVEC, P.A., P.O. BOX 37428, RALEIGH, NC, 27627, US

(73) Assignee: BellSouth Intellectual Property Corporation

(21) Appl. No.: 11/368,890

(22) Filed: Mar. 6, 2006

Related U.S. Application Data
(60) Provisional application No. 60/661,744, filed on Mar. 15, 2005.

(51) Int. Cl. H04L 12/56; H04L 12/28

(52) U.S. Cl. 370/401; 370/389

(57) ABSTRACT

A home applications gateway includes a residential gateway interface that is configured to connect to a residential gateway, and a Java Virtual Machine (JVM) that includes an Open Services Gateway initiative (OSGi) framework configured to execute OSGi Java applications that are downloaded and life cycle managed from a Web server through the residential gateway interface. The OSGi Java applications can include a video monitoring application that is configured to provide in-home and out-of-home access to Internet Protocol (IP)-based home video cameras and video files captured by the IP-based home video cameras, at a Web page. The OSGi Java applications can further include a lighting control application that is configured to control activation and deactivation of home lighting from the Web page. The OSGi Java applications can also include a home monitoring and control application that is configured to monitor home sensors and take action upon their activation.

### CROSS REFERENCE TO RELATED APPLICATION

This application claims the benefit of and priority to U. S. Provisional Patent Application No. 60/661,744, filed Mar. 15, 2005, the disclosure of which is hereby incorporated herein by reference.

### FIELD OF THE INVENTION

This invention relates to communications systems, methods and computer program products, and more particularly to home communications systems, methods and computer program products.

### BACKGROUND OF THE INVENTION

Residential gateways are being developed and marketed for home use. A residential gateway is an intelligent networking device that provides connectivity between internal home networks and external Internet access networks. A residential gateway can use existing networks, such as Digital Subscriber Line (DSL), cable or regular phone lines. Different home systems, such as a security system, a lighting system and an entertainment system in a home can interact with one another through the residential gateway. A residential gateway can allow access to these multiple networks, devices and services with a single point of connection, from a personal computer, mobile phone and/or other handheld device. Residential gateways are described, for example, in an article entitled What Is a Residential Gateway and what can it deliver?, by David Gaw (Home Toys, August 2000). Unfortunately, the complexity of installing, configuring and/or maintaining a residential gateway may at least partially offset the potential advantages of using a residential gateway.

### SUMMARY OF THE INVENTION

Some embodiments of the invention provide a home applications gateway that includes a residential gateway interface that is configured to connect to a residential gateway, and a Java Virtual Machine (JVM) that includes an Open Services Gateway initiative (OSGi) framework configured to execute OSGi Java applications that are downloaded and life cycle managed by a service provider through the residential gateway interface. In some embodiments, the OSGi Java applications include a video monitoring application that is configured to provide in-home and out-of-home access, at a Web page, to Internet Protocol (IP)-based home video cameras and video files captured by the IP-based home video cameras. In other embodiments, the OSGi Java applications further include a lighting control application that is configured to control activation and deactivation of home lighting from the Web page. In still other embodiments, the OSGi applications further include a home monitoring and control application that is configured to monitor home sensors and take action upon activation thereof.

According to some embodiments of the present invention, a home applications gateway may be combined with a residential gateway. In some embodiments, the home applications gateway may be combined with a conventional residential gateway. In other embodiments, the residential gateway may include a broadband modem (such as a Digital Subscriber Line (DSL) modem) that is configured to communicate with an IP network over a broadband line (such as a DSL line), a home applications gateway interface that is configured to communicate with the home applications gateway, a twisted pair modem that is configured to communicate with home devices over home twisted pair cable, a power line communications modem that is configured to communicate with home devices over home power lines and a coaxial cable modem that is configured to communicate with home devices over home coaxial cable. In some embodiments, a wireless modem that is configured to communicate with home devices over home wireless technology is also provided. In some embodiments, the home applications gateway and the residential gateway are contained in a common cabinet.

A home applications gateway and a residential gateway may also be combined with a broadband home security system according to some embodiments of the present invention. The broadband home security system is responsive to home security. sensors to provide signals to a home security monitoring center through the residential gateway via IP protocol. In some embodiments, the broadband home security system is further configured to allow a phone call to be conducted through the residential gateway simultaneous with the signals that are provided to the home security monitoring center. In other embodiments, the broadband home security system includes wireless communications backup via IP protocol, and battery backup, and may be contained in a common cabinet with the home applications gateway and the residential gateway.

Residential gateways according to yet other embodiments of the present invention include a broadband modem, such as a DSL modem, a twisted pair modem, a power line communications modem, a coaxial cable modem and a controller. The broadband modem is configured to communicate with an external network over a broadband line, such as a DSL line. The twisted pair modem is configured to communication with home devices over home twisted pair cable. The power line communications modem is configured to communicate with home devices over home power lines. The coaxial cable modem is configured to communicate with home devices over home coaxial cable. Finally, the controller is configured to coordinate communication between the external network and the home devices over the modems. In other embodiments, the residential gateway may also include an Ethernet switch that is configured to communicate with home devices over Ethernet cables, and an analog voice interface that is configured to provide voice communications with home devices. In these embodiments, the controller may be further configured to coordinate communications between the external network and the home devices over the Ethernet switch and the analog voice interface.

Residential gateways and home applications gateways according to some embodiments of the present invention, may provide home security applications. In some embodiments, home security parameters are specified at a network provider Web page. A home security application package is then downloaded to a home applications gateway through a residential gateway in the home that is connected to a Web server by an external network, in response to the specifying of the home security parameters. Notification of a security-triggering event is received from a home device that is connected to the residential gateway by twisted pair, coaxial, power line cable and/or wirelessly. Security multimedia content from a home video camera that is connected to the residential gateway by twisted pair, coaxial, power line cable and/or wirelessly, is stored at the application services gateway in response to the triggering event. Transmission of at least some of the stored multimedia content is then provided to an external home security-monitoring center through the residential gateway and the external network, while simultaneously enabling voice communication over the external network through the residential gateway. In other embodiments, messages are transmitted to at least one device that is external to the home in response to the security-triggering event, through the residential gateway and the external network. The triggering event can be initiated responsive to a heat sensor, audio sensor, motion detector and/or video processing. Moreover, in some embodiments, communication between the residential gateway and the external network takes place using a broadband modem.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims

### BRIEF DESCRIPTION OF THE DRAWINGS

FIG. 1 is a block diagram of a home applications gateway and a residential gateway according to various embodiments of the present invention.

FIG. 2 is a block diagram of a residential gateway according to various embodiments of the present invention.

FIG. 3 is a block diagram of a common cabinet including a residential gateway, a home applications gateway and a broadband security system according to various embodiments of the present invention.

FIG. 4 is a flowchart of operations that may be performed to provide home security applications according to various embodiments of the present invention.

FIG. 5 is a block diagram of home networking using a residential gateway and a home applications gateway according to various embodiments of the present invention.

FIG. 6 illustrates a user interface of a family homepage according to various embodiments of the present invention.

FIG. 7A is a block diagram of a home services cabinet and components and interconnections thereof according to various embodiments of the present invention.

FIG. 7B is a block diagram of a residential gateway of FIG. 7A and various components and interconnections thereof according to various embodiments of the present invention.

FIG. 8 is a block diagram of a home services cabinet including components thereof and interconnections thereof according to various embodiments of the present invention.

FIGS. 9-13 are block diagrams of various home-networking applications that may use a home service cabinet of FIG. 8 according to various embodiments of the present invention.

FIG. 14 is a block diagram of a wireless residential gateway and a home applications gateway according to some embodiments of the present invention.

FIGS. 15-18 are block diagrams of various home network connections using a WiFi residential gateway and a home applications gateway of FIG. 14 according to various embodiments of the present invention.

### DETAILED DESCRIPTION

The present invention now will be described more fully hereinafter with reference to the accompanying FIGS., in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. In contrast, the term “directly” means there are no intervening features, integers, steps, operations elements and/or components present. As used herein the term “and/or” includes any and all combinations of one or more of the associated listed items and may be abbreviated as “/”. It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The present invention is described below with reference to block diagrams and/or flowchart illustrations of methods, apparatus (systems) and/or computer program products according to embodiments of the invention. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a wireless connection, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

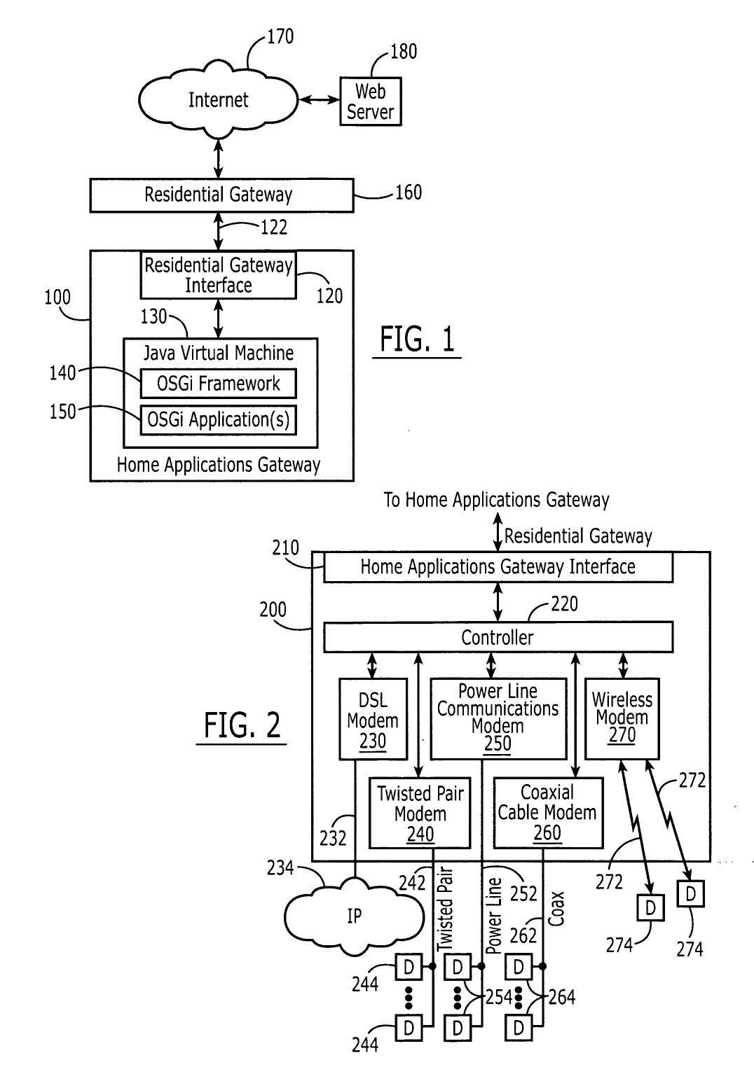

FIG. 1 is a block diagram of a home applications gateway according to some embodiments of the present invention. As shown in FIG. 1, a home applications gateway 100 includes a residential gateway interface 120 that is configured to connect to a residential gateway 160 using, for example, an Ethernet connection 122. A Java Virtual Machine (JVM) 130 is also included in the home applications gateway 100. The JVM 130 includes an Open Services Gateway initiative (OSGi) framework 140 that is configured to execute one of more OSGi Java applications 150 (also referred to herein simply as “OSGi applications”). The OSGi Java applications are downloaded into the home applications gateway 100 and life cycle managed by a service provider, for example from a Web server 180 that is connected to an Internet Protocol (IP) network 170, such as the Internet, via the residential gateway 160.

As is well known to those having skill in the art, Java is a portable and architecturally neutral language. Java source code is compiled into a machine independent format that may be run on machines configured with a Java runtime system known as a Java Virtual Machine (JVM). The JVM may be implemented by emulating a processor through the use of software on a real machine. Accordingly, machines running under diverse operating systems, including UNIX and Windows NT, having a JVM can execute the same Java program.

As is well known to those having skill in the art, the OSGi framework is promulgated by the OSGi Alliance and specifies a Java-based service platform that can be remotely managed. A core part of the OSGi specification is a framework that defines an application life cycle model and a service registry. Based on this framework, a large number of OSGi services have been defined. The framework implements an elegant, complete and dynamic component model that allows applications to be remotely installed, started, stopped, updated and uninstalled. OSGi is described in great detail on the Website osgi.org and will not be described further herein.

By providing a JVM 130 that runs an OSGi framework 140 and OSGi Java applications 150 in a home applications gateway 100, the OSGi applications 150 can be life cycle managed from the Web server 180, which may belong to a network provider. The installation, activation, updating and uninstalling of OSGi applications can thereby be controlled remotely, based on, for example, services to which the home user has subscribed and parameters that are input by the home user, without the need for an elaborate installation or activation in the home by the home user and/or by network personnel. Accordingly, the potential savings of using a residential gateway need not be offset by the additional costs and/or complexity of installing and/or maintaining the residential gateway.

Thus, in some embodiments, the OSGi Java applications 150 can all be remotely managed and administered by a service provider. A customer can go to a website and subscribe to a service, and the Java application(s) can then be automatically downloaded across the network 170 through the residential gateway 160 to the home applications gateway 100. If a customer stops subscribing to a service, then the Java application(s) can be remotely removed from the home applications gateway 100. If an upgrade or patch is needed for a Java application 150 that is executed on the home applications gateway 100, the upgrade or patch can be applied remotely without the need for customer involvement.

Various detailed designs of home applications gateways 100 according to various embodiments of the present invention will be described below. In general, however, the OSGi applications 150 can include a video monitoring application that is configured to provide in-home and out-of-home access, at a Web page, such as a family Web page provided by a network provider, to IP-based video cameras and video files captured by the IP-based home video cameras. The Web page may be used to administer the services and provide a secure communication pathway to the home network. Thus, when a user is away from home, the user can access live video via cameras in the home from a personal computer, Personal Digital Assistant (PDA) and/or cell phone through the Web site, which can provide a secure connection to the home. Moreover, when a user is away from home, the user can monitor sensors, such as temperature sensors, or control power modules, such as for lighting, remotely using the above devices via the Web site, which provides a secure connection to the home. The OSGi applications 150 can further include a lighting control application that is configured to control activation and deactivation of home lighting from the Web page. Other OSGi applications 150 can include a home monitoring and control application that is configured to monitor home sensors and take action upon activation thereof. Yet other OSGi applications may be provided, as will be described in detail below.- Other applications that can be managed and controlled can include heating and air conditioning systems, lawn sprinkler systems, meter reading (water, natural gas and/or electricity) and/or biomedical monitoring equipment.

FIG. 2 is a block diagram of a residential gateway, such as a residential gateway 160 of FIG. 1, according to some embodiments of the present invention. It will be understood, however, that a residential gateway of FIG. 2 may be used independent of the home applications gateway 100 of FIG. 1.

Referring now to FIG. 2, when the residential gateway 200 interfaces with the home applications gateway 100, a home applications gateway interface 210 may be provided. The residential gateway 200 also includes a broadband modem, such as a Digital Subscriber Line (DSL) modem 230, that is configured to communicate with an IP network 234 over a DSL line 232. It will be understood by those having skill in the art that the DSL modem 230 may also be provided separate from the residential gateway 200 in some embodiments, in which case a DSL modem interface may be provided instead of the DSL modem 230. The broadband modem can also include a cable, optical fiber and/or other broadband modem. A twisted pair modem 240 is also provided that is configured to communicate with home devices 244 such as conventional telephone devices, over twisted pair cable 242. A power line communications modem 250 is also provided that is configured to communicate with home devices 254, such as power line communication enabled video cameras, over a home power line 252. A coaxial cable modem 260 is also provided that is configured to communicate with home devices 264, such as television set top boxes, over coaxial cable 262. A wireless modem 270 also may be provided, that is configured to communicate with wireless home devices 274 over wireless links 272. In some embodiments, WiFi technology is employed, wherein a WiFi wireless access point is integrated into the residential gateway 200 or connected to the residential gateway 200 by Ethernet, power line, twisted pair and/or other wired connections. A controller 220 is also provided that is configured to coordinate communications between the external network 234 and the home devices 244, 254 and 264 via the modems 230, 240,250 and 260. The controller 220 can include processor and/or memory devices therein and/or attached thereto to implement the described functionality.

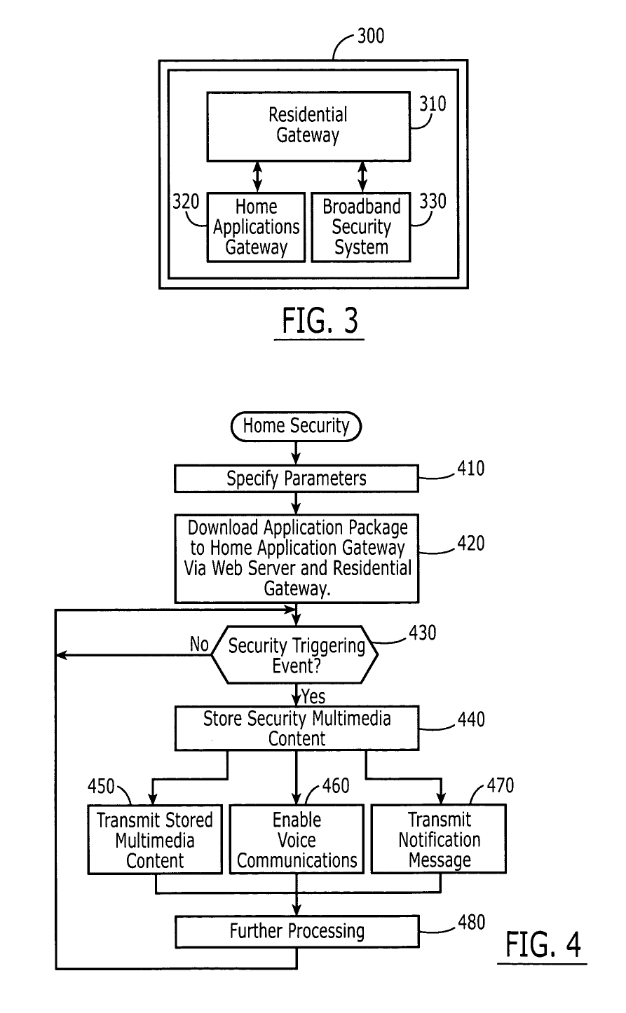

FIG. 3 is a block diagram illustrating integration of a residential gateway and a home applications gateway according to some embodiments of the present invention. In particular, as shown in FIG. 3, a common cabinet 300 may house a residential gateway 310, which may correspond to the residential gateway 160 of FIG. 1 and/or 200 of FIG. 2, and a home applications gateway 320, which may correspond to the home applications gateway 120 of FIG. 1. In some embodiments, a broadband home security system 330 is also housed in the common cabinet 300. The broadband home security system 330 is responsive to home security sensors to provide signals to a home security monitoring center through the residential gateway 310, as will be described in greater detail below. In some embodiments, by using DSL connections, the broadband home security system 330 is configured to allow a phone call to take place, for example with security and/or emergency personnel, through the residential gateway 310, simultaneous with the signals that are provided to the home security monitoring center. Moreover, in some embodiments, the interface between the residential gateway 310 and the broadband security system 330 is an IP interface, rather than the conventional analog telephone line. IP messages, rather than conventional DTMF codes, may be communicated between the broadband security system 330 and the residential gateway 310.

FIG. 4 is a flowchart of operations that may be performed to provide home security according to various embodiments of the present invention. At Block 410, home security parameters are specified by a home user, for example at a network provider Web page. It will be understood by those having skill in the art that the parameters may also be specified by the network provider in addition to or instead of the home user. Then, at Block 420, a home security application package is downloaded to a home applications gateway, such as the home applications gateway 100 or 320 described above, through a residential gateway, such as the residential gateway 160, 200 or 310 described above, via a Web server, such as the Web server 180 of FIG. 1, and an external network, such as the Internet 170 of FIG. 1; in response to the specifying of home security parameters. At Block 430, notification of a security-triggering event is received from a home device, such as a video camera and or sensor, that is connected to the residential gateway by a twisted pair, coaxial, power line cable and/or wireless link. The triggering event can be initiated responsive to a heat sensor, audio sensor, motion detector and/or video processing.

In response to the triggering event, security multimedia (audio/video) content from a home video camera is stored at the application services gateway as shown at Block 440. The multimedia content can be stored locally on a mass storage device and/or on a platform in the network. The residential gateway and/or the home applications gateway simultaneously enables: (1) the transmission of the stored multimedia content to an external home security monitoring center through the residential gateway and the external network at Block 450; (2) voice communications over the external network over the residential gateway at Block 460; and (3) transmission of notification messages at Block 470, for example, to a cell phone, pager or email address that was specified. It will be understood by those who have skill in the art that, in other embodiments, only two of three Blocks 450, 460 and 470 may be performed simultaneously. Moreover, in other embodiments, the simultaneous actions of Blocks 450, 460 and/or 470 may also occur at least partially simultaneously with the storing of security multimedia content of Block 440. Further processing may then be performed at Block 480.

Some embodiments of the present invention provide broadband home security systems, methods and/or computer program products. These embodiments can use an “always on” broadband data connection and in-home video cameras along with remote monitoring, to provide home security. The always on broadband data connection can be provided utilizing DSL, cable modem, fiber to the premises and/or other comparable always on, broadband data communication technologies. In some embodiments, one or more cameras (video/audio) in the customer's home may be accessed remotely by a monitoring service, but in some embodiments, only during alarm conditions. In some embodiments, the customer, such as the homeowner, may always have access to cameras (video/audio) when in the home or away from the home.

More specifically, the cameras may be equipped with remote pan, tilt and zoom capabilities, audio capabilities, a video/audio buffer and a Web server. The cameras may be on all of the time, and accessible in the home from any browser-equipped device on the home network. Moreover, customers may be able to remotely access the cameras when they are away from home, via the Internet and a browser-equipped device, such as a personal computer, Personal Digital Assistant (PDA) and/or cell phone device. In some embodiments, when triggered, as by an alarm condition, the cameras, when equipped with a video/audio buffer, may be able to capture a predetermined amount of motion video and audio, such as 50 seconds of motion JPEG video with audio or MPEG4 video and audio, by storing video/audio. The trigger event could be initiated by some form of a sensor or detector device, such as a temperature sensor, a water sensor, motion detector, sound detector and/or a window/door contact.

At the time that a trigger event occurs, the buffer in the camera only contains pre-event video/audio. The video/audio buffer operates on a first in and first out basis. As time passes after a trigger event, the buffer will contain both pre-trigger and post-trigger video/audio. At any point in time after the trigger event, the video/audio buffer can be captured and sent, for example via File Transfer Protocol (FTP), to a storage device located in the home and/or out of the home. Some portion of this captured vide/audio will be prior to a trigger event, and the other portion will be after the trigger event. For example, assuming a 50 second buffer, 30 seconds of video/audio may be captured prior to a trigger event, and 20 seconds of video/audio may be captured after a trigger event. The video/audio may be transmitted via FTP to a storage device out of the home, such as a site in the network. The cameras may communicate with a home applications gateway using wired and/or wireless connections and Internet Protocol. Examples of wired connections may include home telephone wiring, home electrical wiring, home coax wiring or dedicated CAT 5E wiring, and examples of wireless connections may include WiFi, Bluetooth and/or other short-range wireless connections. One example of a network-enabled video camera is the Panasonic Network Camera KX-HCM10.

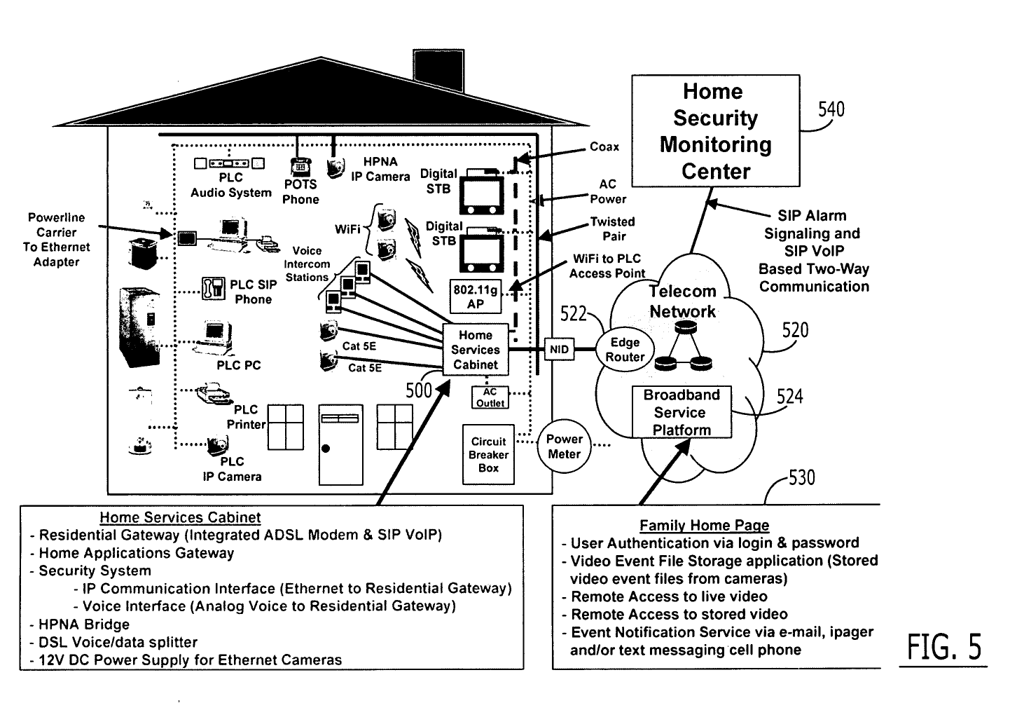

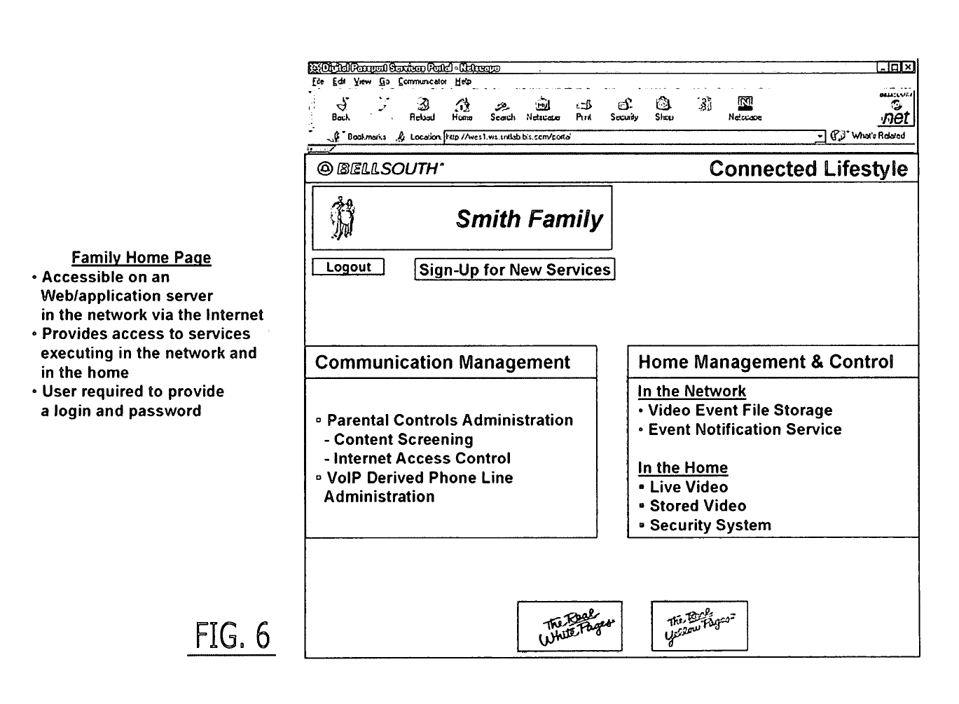

FIG. 5 is a block diagram of DSL-based broadband home security systems, methods and/or computer program products according to various embodiments of the present invention. As shown in FIG. 5, a home services cabinet 500 can include therein one or more of the components shown in FIG. 1, and may be connected to a telecom network 520 via an edge router 522, to provide DSL services, such as ADSL services. The telecom network 520 can also provide a home page, also referred to as a family home page 530, that can provide one or more of the functionalities listed in FIG. 5. FIG. 6 illustrates a user interface that may be provided for a family home page 530, according to some embodiments of the present invention. A monitoring center 540 also may be provided and may be interfaced as shown in FIG. 5. It will be understood that subcombinations of the elements shown, in FIG. 5, and/or additional elements, may be used in various embodiments of the invention.

More specifically as shown in FIG. 5, the home services cabinet 500 may include therein a residential gateway, a home applications gateway and a security system according to any of the embodiments described herein. The residential gateway may include an integrated DSL modem and Session Interface Protocol (SIP) Voice-over-Internet Protocol (VoIP) connection. This security system can include an IP communication interface using, for example, Ethernet to the residential gateway, and a voice interface using an analog voice to the residential gateway. These two communication interfaces may be activated simultaneously.

The home services cabinet 500 may also include a Home Phoneline Networking Alliance (HomePNA™) bridge, a DSL voice/data splitter and a 12-volt DC power supply for the Ethernet cameras. It will be understood by those having skill in the art that one or more of the above components may be provided outside the home services cabinet 500 and, in some embodiments, need not be provided at all.

The family home page 530 can allow user authentication via login and password, video event file storage to store video event files from cameras, remote access to live video, remote access to stored video and/or an event notification service by email, by pager, text messaging, cell phone and/or video devices.

As illustrated in FIG. 5, within the home, the home services cabinet 500 may be connected to cameras, personal computers, monitors, sensors and/or other equipment using twisted pair, electrical wiring, coaxial cable, CAT 5 cable, wireless and/or other connections that can use IP protocol. In some embodiments, the devices that are connected to the home services gateway are equipped with HomePNA adapters. As is well known to those having skill in the art, HomePNA is a high speed, local area networking technology that uses the existing phone wires in the home to share a single Internet connection with several devices in the home. In some embodiments, the devices are connected to the home services gateway with Power Line Carrier (PLC) adapters or products with integrated PLC technology, such as HomePlug 1.0 technology. As is well known to those having skill in the art, HomePlug is a high speed, local area networking technology that uses the existing electrical wires in the home to share a single Internet connection with several devices in the home.

Moreover, as shown in FIG. 6, the family home page can provide communication management (for example, parental control administration and/or VoIP-derived phone line administration) and can also provide home management and control functionality such as video event file storage, event notification service and management of live video, stored video and/or a security system. The family home page may be accessible to a Web application server via the Internet and provides access to services executing in the network and in the home.

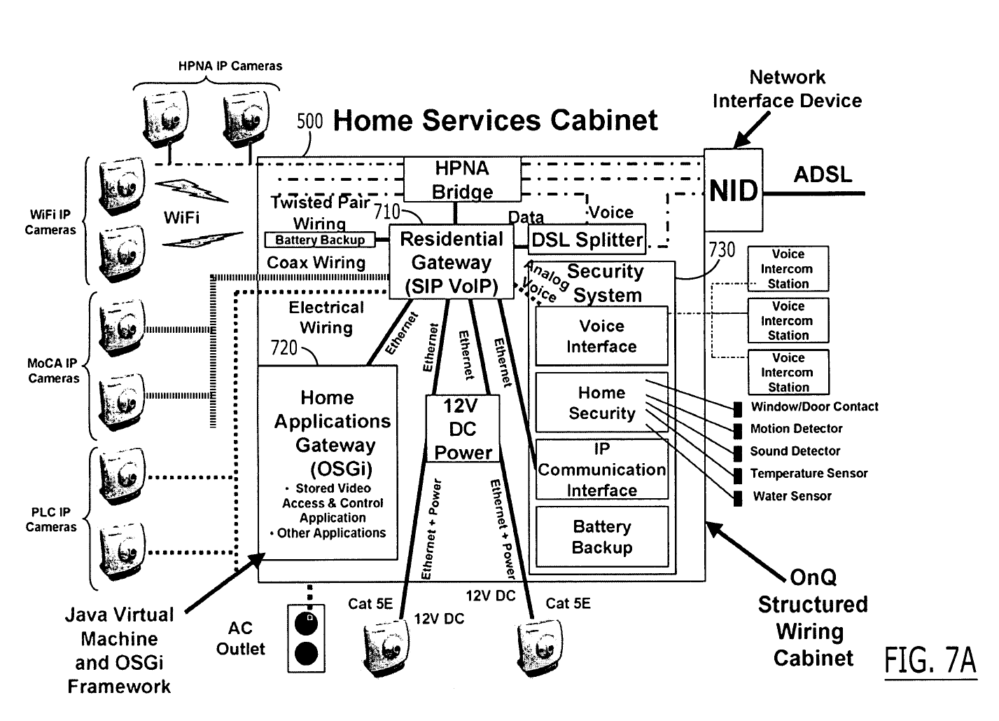

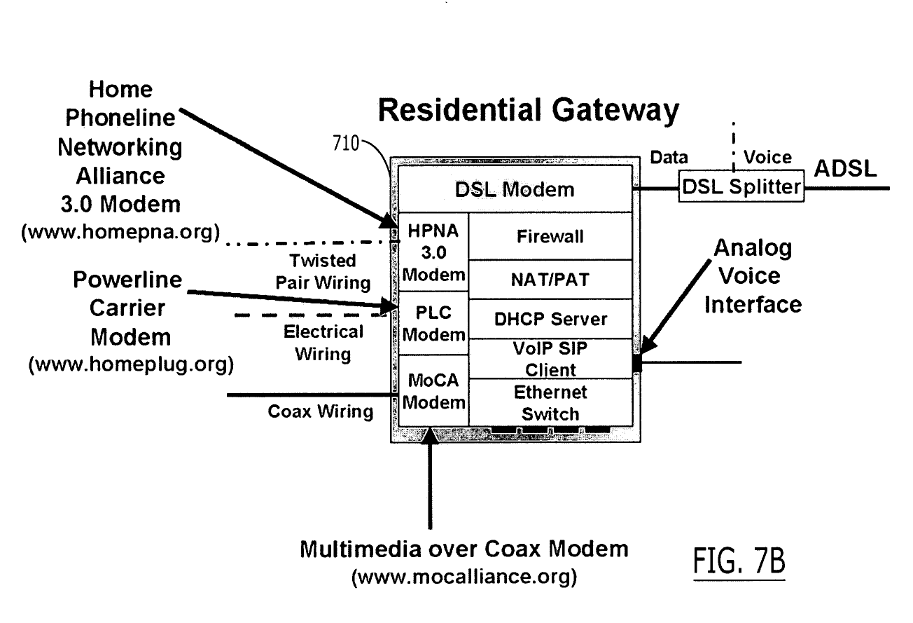

FIG. 7A is a block diagram of a home services cabinet 500, according to various embodiments of the present invention. As shown in FIG. 7A, a home services cabinet 500 can interface with a Network Interface Device (NID), and can include a DSL voice/data splitter, a residential gateway 710 with an SIP VoIP client (which may correspond to any of the residential gateway architectures described herein), an analog voice interface, a security system 730 (which may correspond to any of the security system architectures described herein) and/or a home application gateway 720 (which may correspond to any of the home application gateway architectures described herein). Processor and/or memory devices may also be provided, to implement the described functionality. The platform used for the home applications gateway 720 may be an OSGi service platform and/or other common service platforms. As is well known to those having skill in the art, the OSGi specifications define a standardized, Java-based computing environment for network devices. By adding an OSGi service platform to a network device, such as a home applications gateway, the capability may be provided to manage a life cycle of the software components on the device from anywhere in the network. Software components can be installed, updated and/or removed on the fly, without having to disrupt the operation of the device. The OSGi service platform can include a JVM and an embedded server running Java applications. OSGi home services can include remote/local video/audio monitoring with sensors including automatic event notification, video telephony, remote/local energy management and control, remote/local lighting control, remote/local lawn sprinkler system control, remote/local health care monitoring, family services with local/remote access (calendar, directory, message board, etc.), multimedia storage/retrieval (photos, video, games, e-books, etc.) and/or other home services.

The cabinet 500 may be a structured wiring cabinet that may be marketed by OnQ Technologies, and/or another conventional enclosure. In some embodiments, battery backup (e.g., 12V DC power) may be provided for the cameras, the residential gateway, the security system and/or other components. It will be understood that subcombinations of the elements shown in FIG. 7A, and/or additional elements, may be provided in various embodiments of the. invention.

Embodiments of the present invention also may be combined with one or more other IP-based services, such as broadband, bandwidth on demand, consumer voice over IP, wireless/wireline integration, IPTV and/or other services. These services may be delivered to consumers using DSL technology to provide the data transport in the home. Conventionally, DSL is used primarily for high speed Internet access. However, embodiments of the present invention can expand DSL into the realm of home security and/or other applications.

Embodiments of the invention can make broadband data networking in consumers' homes as ubiquitous and easy to use as the analog telephone network that is in their homes. In some embodiments, no additional burdens may be placed on a user, because there need not be a system administrator in the home. Internet appliances, such as Internet screen phones, Web terminals, set top boxes, wireless Web pads, Web-enabled microwave ovens, etc., may be purchased, taken into the home, plugged in and used. Moreover, these Internet appliances may be moved from one location to another by simply unplugging from one location and plugging into another location. Embodiments of the present invention also may allow remote access to services, such as home security and management services executing in the home.

FIG. 7B is a block diagram of DSL-based broadband residential gateway systems, methods and/or computer program products 710 according to some embodiments of the present invention. It will be understood that subcombinations of the elements shown in FIG. 7B, and/or additional elements, may be provided in various embodiments of the invention. It will also be understood by those having skill in the art that, in addition to the DSL modem shown, a power line carrier modem, a HomePNA modem, a Multimedia over Coax Alliance (MoCA) modem, WiFi connections and/or other access ports also may be used. Processor and/or memory devices also may be included to implement the described functionality.

Additional discussion of broadband home security systems, methods and/or computer program products according to various embodiments of the invention now will be provided. In particular, a complaint of monitored home security service customers today is that, under an alarm condition, the customer may not be able to use their phone to call emergency services (911), because their home security system seizes their phone line in order to signal the monitoring center. Broadband home security services according to some embodiments of the present invention can reduce or eliminate this problem because, under an alarm condition, the home security system can send an IP message over DSL to the monitoring center and the customer can still be able to use their phone to call 911. Moreover, the IP signaling to the monitoring center during an alarm condition can provide virtually instantaneous communication to the monitoring center, compared to the potentially very slow DTMF signaling that is characteristic of conventional wireline phone-based home security systems. Accordingly, IP signaling over DSL may be used to replace conventional DTMF signaling in home security applications. Moreover, within a broadband home security system, battery backup can be provided for the DSL modem, so that IP signaling can be used to signal the monitoring center under a local power failure condition. In some embodiments, cellular backup can be offered as additional backup. Moreover, within a broadband home security system, VoIP may also be used to provide communication between the customer and the monitoring center during an alarm condition.

Broadband home security systems, methods and/or computer program products according to some embodiments of the present invention may be further enhanced by the addition of remote video/audio monitoring. A technician and/or a consumer can install one or more wired and/or wireless cameras within the customer's home. When an alarm is triggered, some, or all, of the cameras in the home will capture video/audio, including both pre-trigger and post-trigger video/audio, and automatically transmit the video/audio, for example via FTP technology, to a storage device out of the home, such as a site in the network. During alarm conditions, the monitoring center may have secure access to the streaming video/audio from the home, but in some embodiments, only during alarm conditions. The customer may determine which cameras are accessible by the monitoring center. In some embodiments, some cameras may be accessible to a home security monitoring service provider, whereas other cameras may only be available to the homeowner. The customer may always have secure access to streaming video/audio from the home via a personal computer, cell phone and/or other device. The customer may also be automatically notified by email, cell phone, pager and/or other device whenever specified events occur in the home, such as the front doorbell ringing or a door opening. In some embodiments, streaming video/audio from all cameras in the home may be automatically archived on a mass storage device in the home.

Returning to FIG. 5, during an alarm condition, when an agent at the home security monitoring center 540 receives a notification of the alarm, the agent will access the video/audio that had automatically been captured and sent via FTP to a storage site in the network to attempt to determine if the alarm condition is a real alarm condition or a false alarm. In one embodiment the video/audio may be stored on a broadband services platform 524 in the network. After accessing the stored video/audio, the agent will access live video/audio from the cameras in the customer's home. Then, the agent will attempt to establish voice communication with someone in the customer's home by placing an analog phone call, and/or a VoIP phone call, to the customer's home. If the customer's security system is equipped with a Voice Interface module and Voice Intercom Stations, then the agent will establish the voice communication with the customer using VoIP technology from the monitoring center through an analog voice interface between the residential gateway and the voice interface module in the security system to the voice intercom stations, as shown in FIG. 7B.

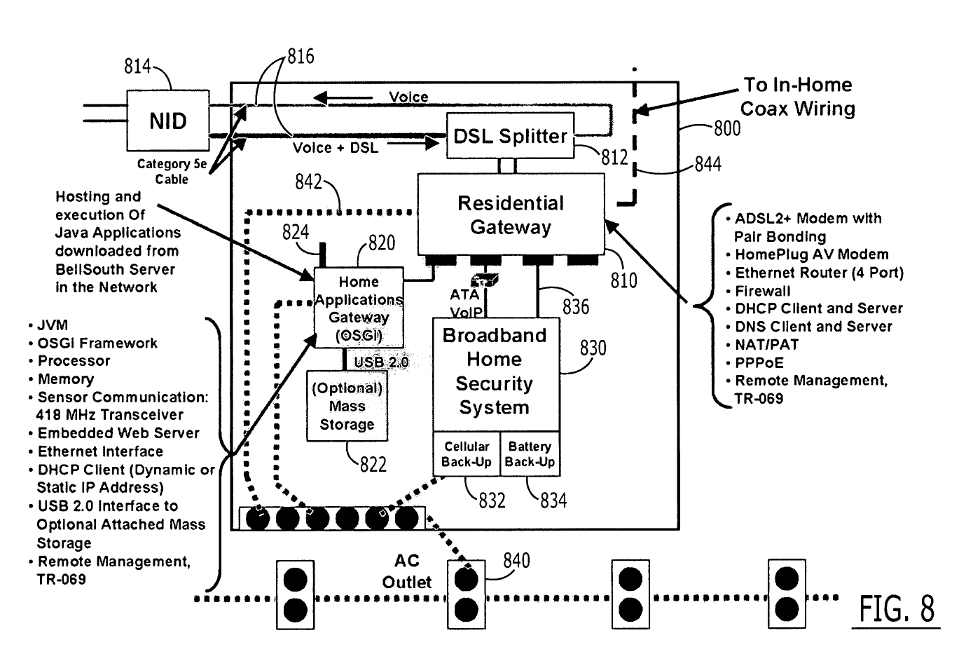

FIG. 8 is a block diagram of systems, methods and/or computer program products according to other embodiments of the present invention. As shown in FIG. 8, a residential gateway 810, a home applications gateway 820 and a broadband home security system 830 are integrated in a home services cabinet 800. These devices may be provided according to any of the embodiments described herein. In embodiments of FIG. 8, the residential gateway is connected to a network by a DSL splitter 812 and a network interface device 814 using category 5E cable 816. The residential gateway 810 may also be connected to the in-home coaxial cable wiring 844 and to the home power lines 842. Ethernet connections 836 also may be provided between the residential gateway 810, the home applications gateway 820 and the broadband home security system 830. Processor and/or memory devices also may be provided, to implement the described functionality.

As shown in FIG. 8, in some embodiments, the residential gateway 810 can include a DSL modem, such as an ADSL 2+ modem with pair bonding, a HomePlug AV modem, an Ethernet router, a firewall, a DHCP client and server, a DNS client and server, NAT/PAT; PPPoE and remote management TRO69 modules. The home applications gateway 820 provides hosting and execution of Java applications downloaded from a server and a network. In some embodiments, the home applications gateway 820 can include a JVM, an OSGi framework, a processor, memory, sensor communication, for example via a 418 MHz wireless transceiver 824, an embedded Web server, an Ethernet interface, a DHCP client, a USB 2.0 interface to an optional attached mass storage 822 and remote management. The 418 MHz wireless transceiver 824 may be used to communicate with sensors (such as door and/or window sensors) and/or control modules (such as power modules and/or thermostats). The power line connections 842 may connect with other AC outlets 840 in the home. The broadband home security system 830 may also include a cellular back-up 832 and/or battery back-up 834. The cellular back-up 832 may be used if the broadband connection to the home is lost. In this case, IP signaling may be performed via a wireless connection to a cellular signaling network.

In some embodiments, the following OSGi applications may be provided on the home applications gateway 820: video monitoring, lighting control and home monitoring and control. Video monitoring applications may provide in-home and out-of-home access to IP video cameras, may capture video events and may archive streaming video events. In some embodiments, archiving may use the optional mass storage 822. Lighting control applications may interface with power modules and provide a simple Web browser interface for lighting control. Home monitoring and control applications may interface with temperature sensors, water sensors, carbon monoxide sensors, window and/or door contacts, etc. Other OSGi applications can include remote meter reading for electric power, natural gas and/or water, energy management applications and/or other applications. If an OSGi framework is running on the home applications gateway 820, each application can be individually downloaded from the server in the network and life cycle managed by the network.

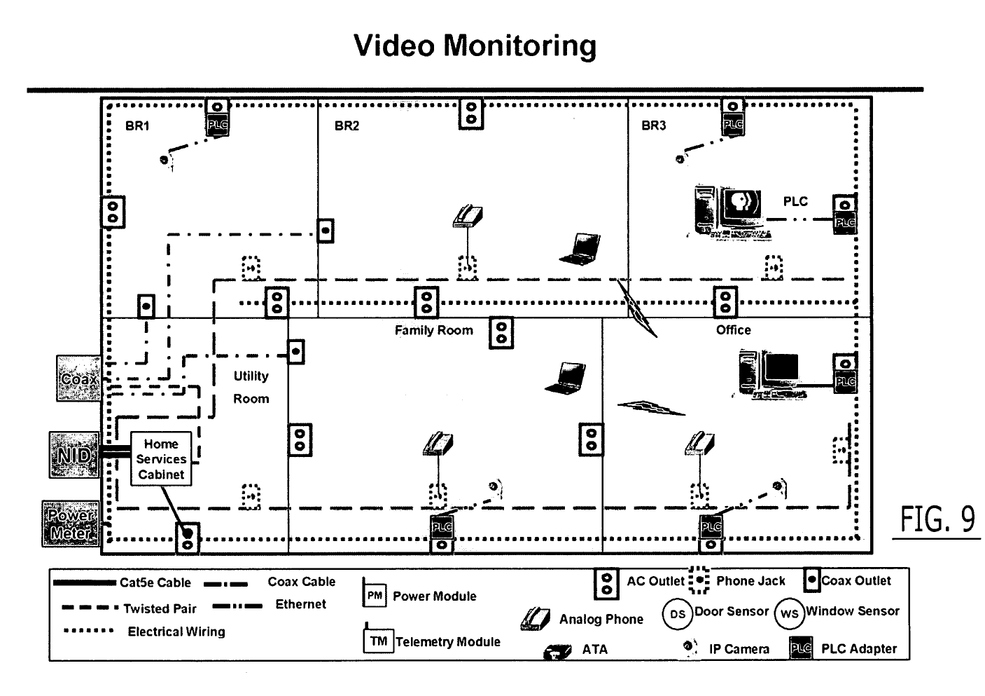

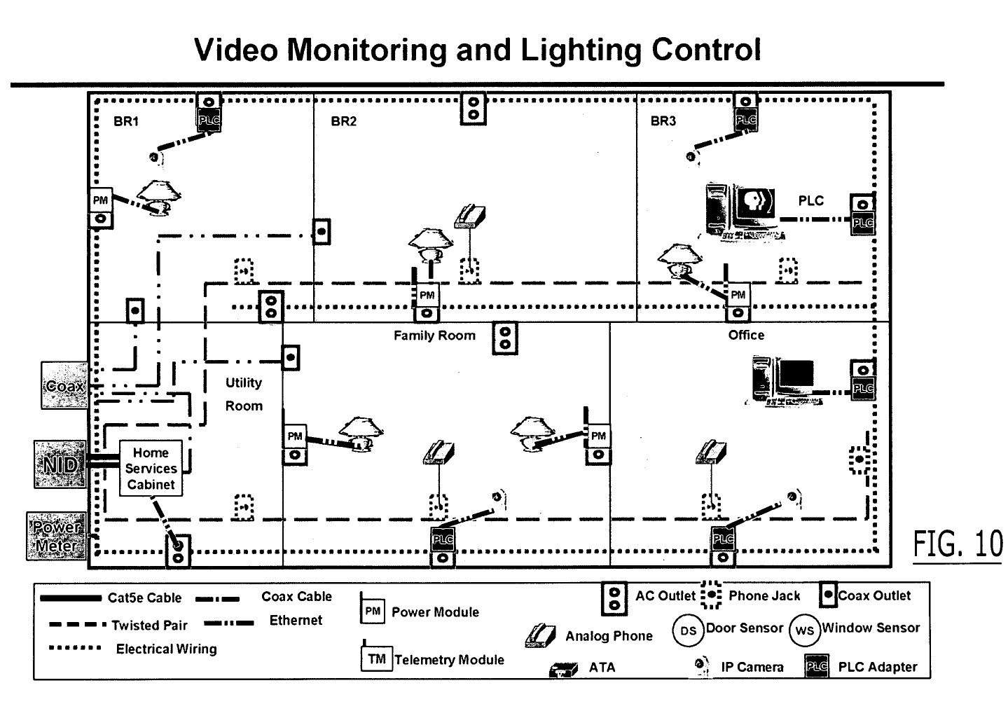

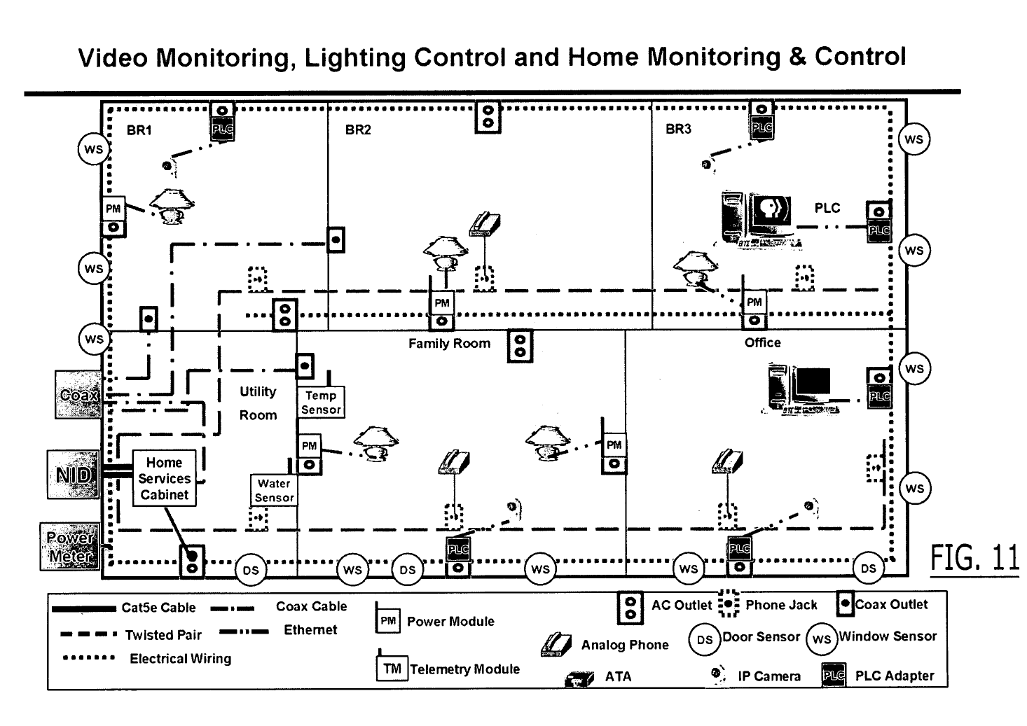

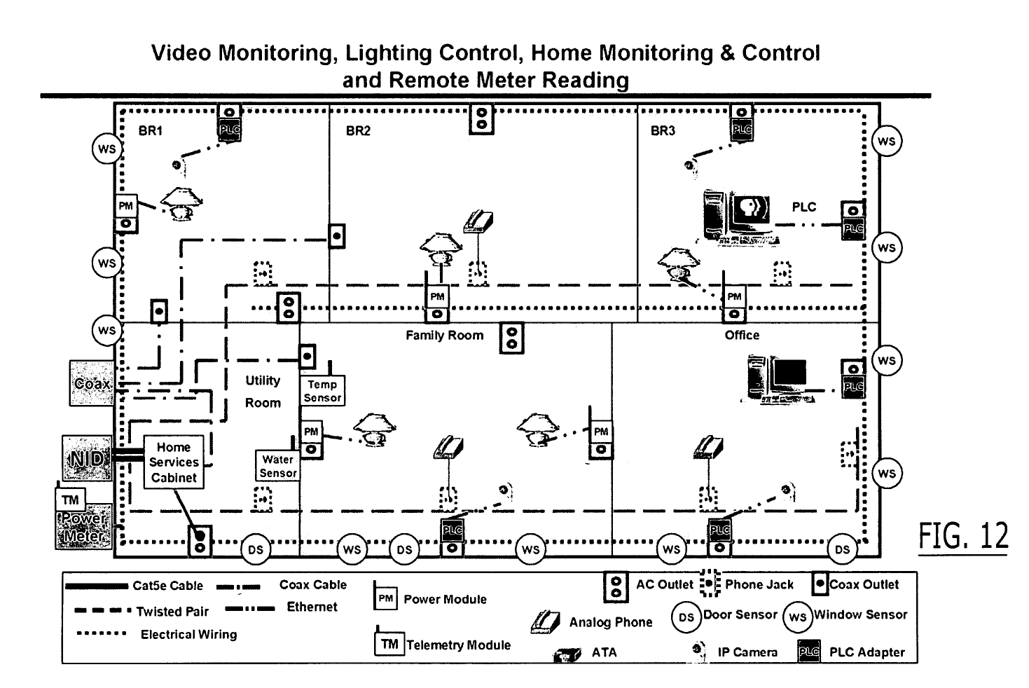

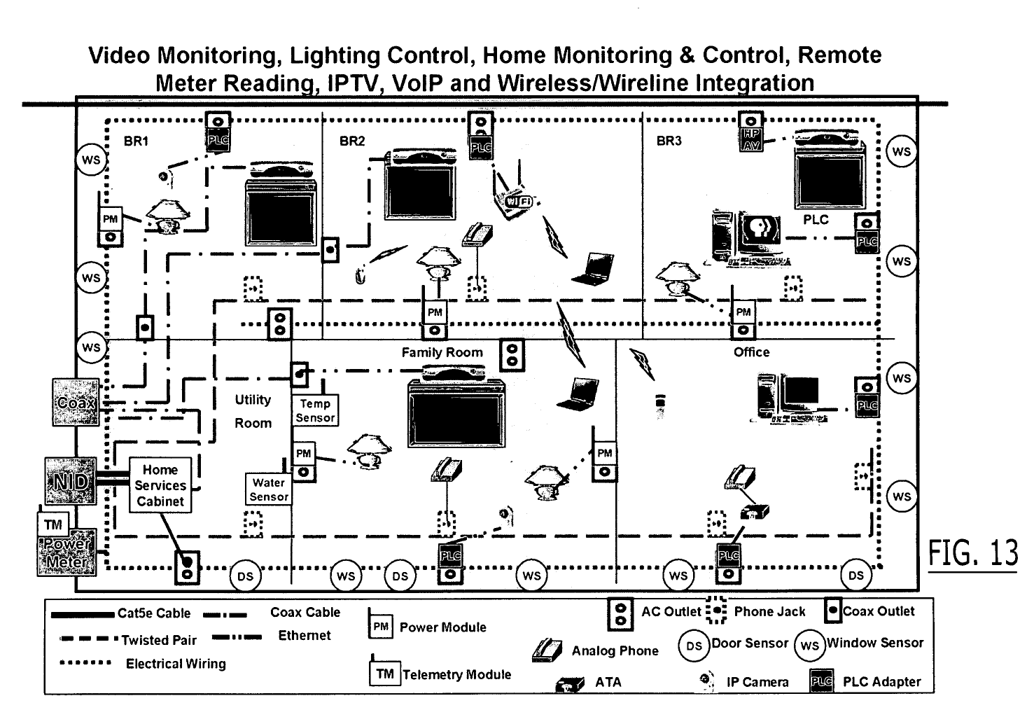

FIGS. 9-13 illustrate configuration of various home networks to provide various applications according to various embodiments of the present application. In the home, three bedrooms (BR1, BR2, BR3) along with a utility room, a family room and an office are illustrated. A legend is provided at the bottom of each FIG, to symbolically illustrate the various components. FIG. 9 illustrates video monitoring applications. FIG. 10 illustrates video monitoring and lighting control applications. FIG. 11 illustrates video monitoring, lighting control and home monitoring and control applications. FIG. 12 illustrates video monitoring, lighting control, home monitoring and control, and remote meter reading applications. Finally, FIG. 13 illustrates video monitoring, lighting control, home monitoring and control, remote meter reading, IPTV, VoIP and wireless/wire line integration applications.

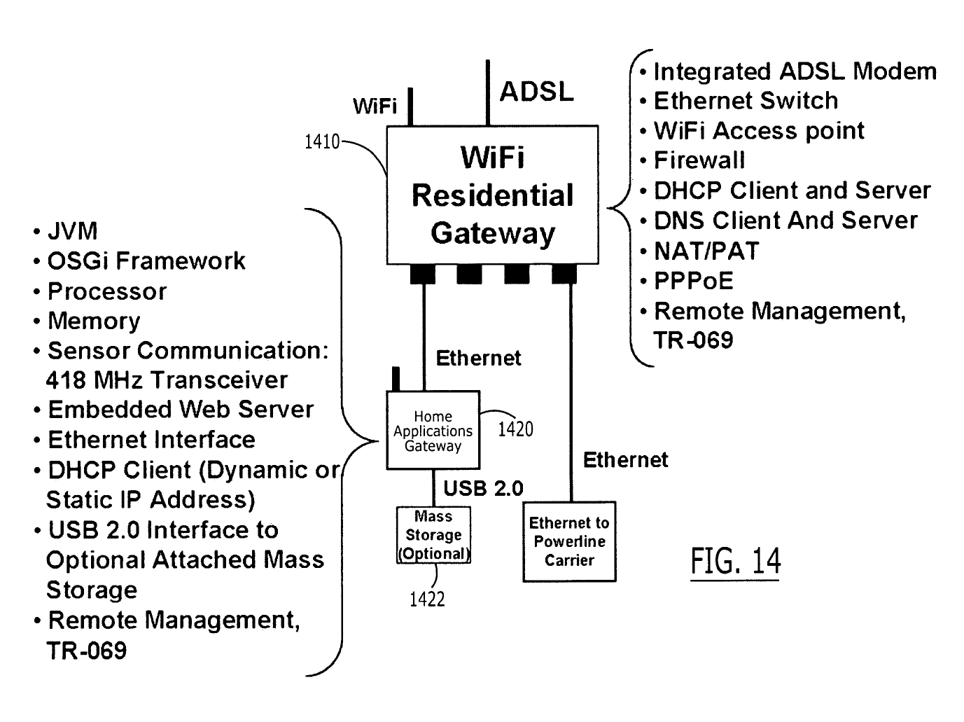

FIG. 14 is a block diagram illustrating a residential gateway 1410 that also includes a wireless connection, such as a WiFi connection. A home applications gateway 1420 may also include a wireless connection, as well as an Ethernet connection. An optional mass storage 1422 also may be provided as was described above. The home applications gateway 1420 may be similar to the home applications gateway 820 of FIG. 8 and need not be described again. Moreover, the WiFi residential gateway 1410 may be similar to the residential gateway 810 with the addition of a WiFi access point connection and need not be described again. The residential gateway 1410 and home application gateway 1420 need not be integrated in a common cabinet as shown in FIG. 14. The applications that may be run using a residential gateway 1410 and a home applications gateway 1420 of FIG. 14 may be similar to those described above in connection with FIG. 8 and need not be described again. Processor and/or memory devices also may be included to implement the described functionality.

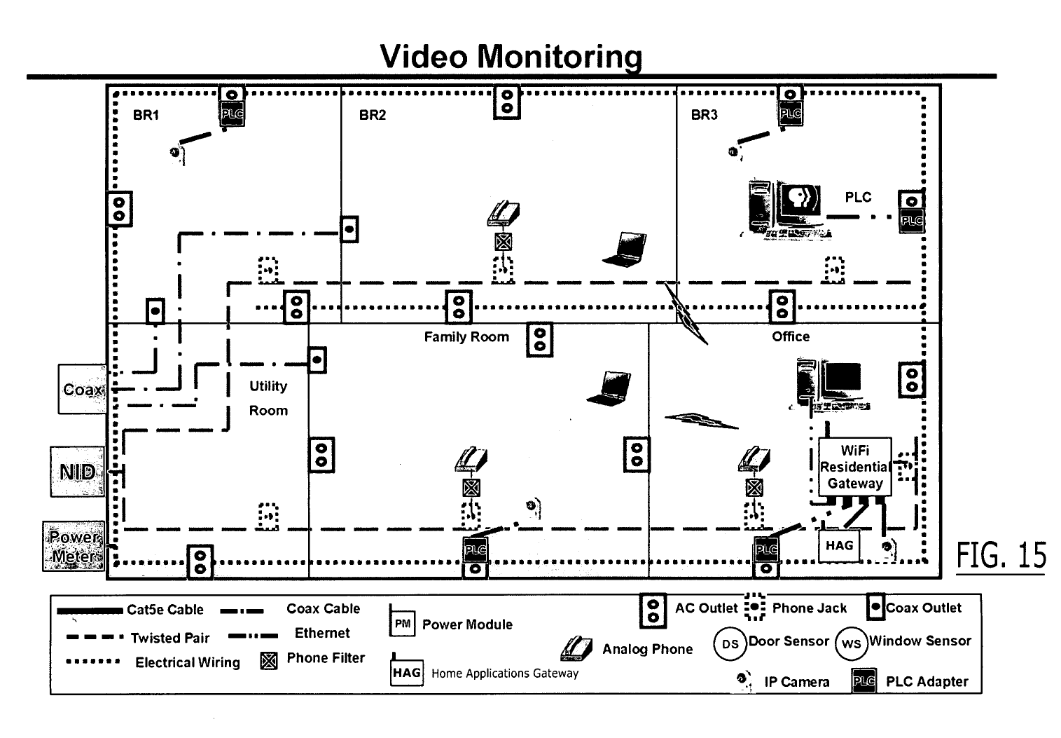

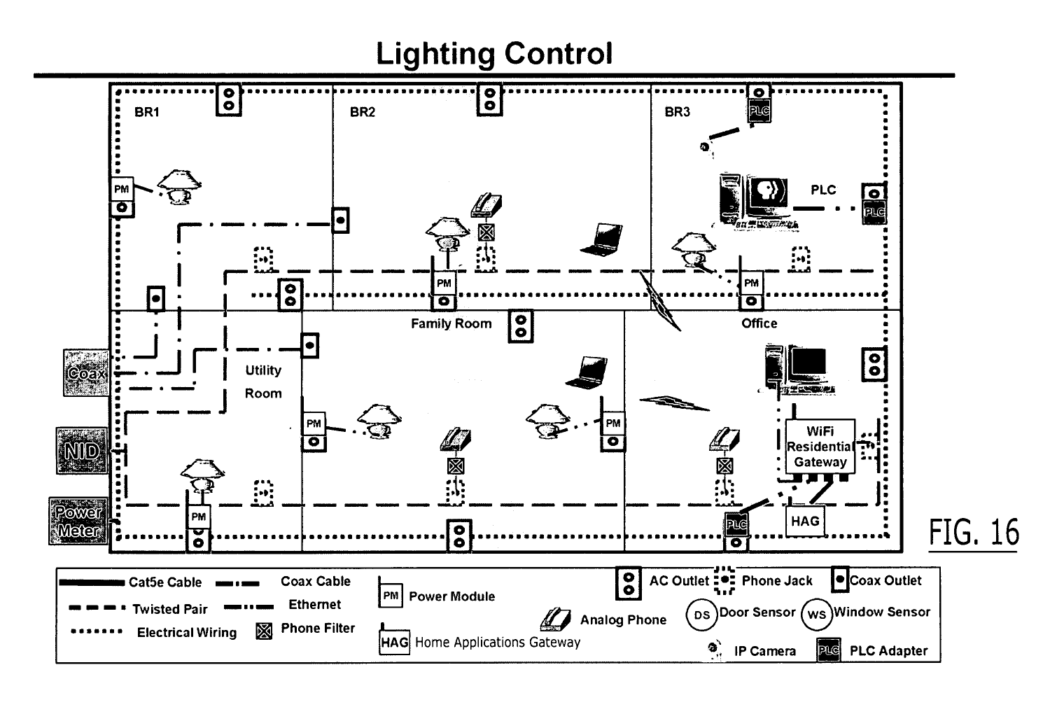

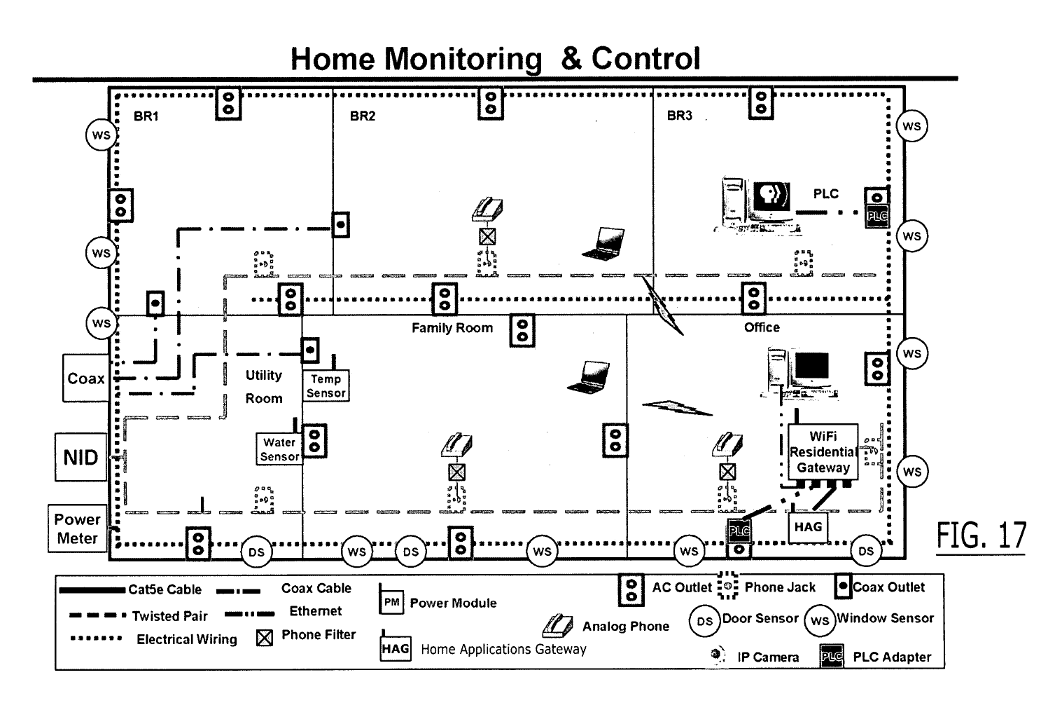

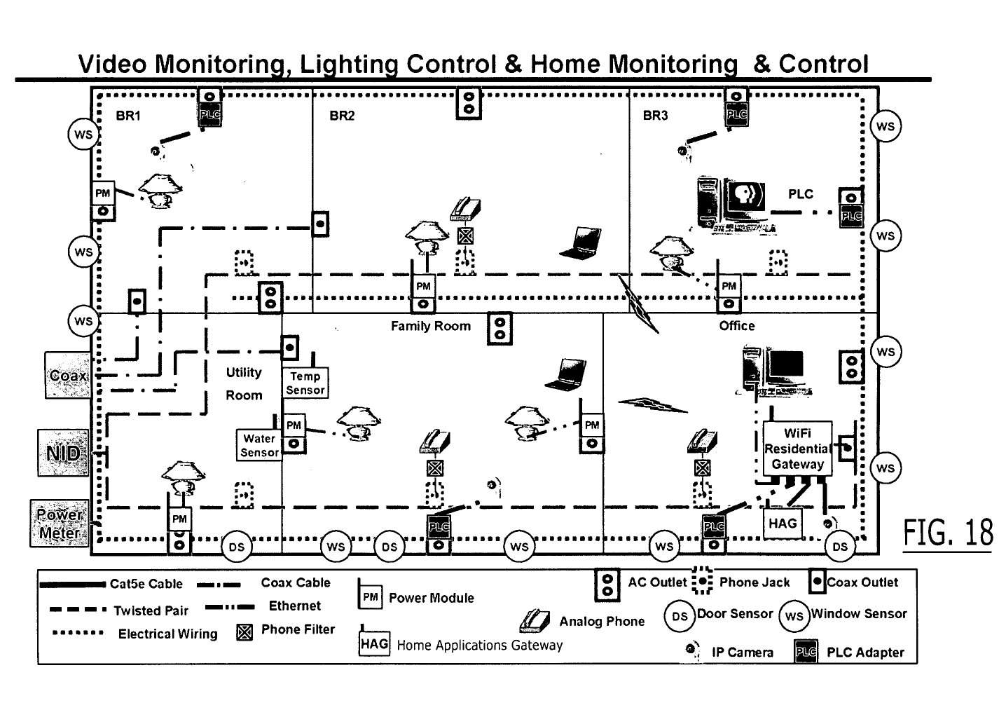

FIGS. 15-18 illustrate how a WiFi residential gateway 1410 of FIG. 15 and a Home Applications Gateway (HAG) 1420 of FIG. 14, may be interconnected to provide various applications. In particular, FIG. 15 illustrates video monitoring, FIG. 16 illustrates lighting control, FIG. 17 illustrates home monitoring and control, and FIG. 18 illustrates video monitoring, lighting control and home monitoring and control.

In the drawings and specification, there have been disclosed embodiments of the invention and, although specific terms are employed, they are used in a generic and descriptive sense only and not for purposes of limitation, the scope of the invention being set forth in the following claims.

1. A home applications gateway, comprising:
a residential gateway interface that is configured to connect to a residential gateway; and
a Java Virtual Machine (JVM) that includes an Open Services Gateway initiative (OSGi) framework configured to execute OSGi Java applications that are downloaded and life cycle managed by a service provider through the residential gateway interface.

2. A home applications gateway according to claim 1 wherein the OSGi Java applications include a video monitoring application that is configured to provide in-home and out-of-home access, at a Web page, to Internet Protocol (IP)-based home video cameras and video files captured by the IP-based home video cameras.

3. A home applications gateway according to claim 2 wherein the OSGi Java applications further include a lighting control application that is configured to control activation and deactivation of home lighting from the Web page.

4. A home applications gateway according to claim 3 wherein the OSGi Java applications further include a home monitoring and control application that is configured to monitor home sensors and take action upon activation thereof.

5. A home applications gateway according to claim 1 in combination with the residential gateway, wherein the residential gateway comprises:
a broadband modem that is configured to communicate with an Internet Protocol (IP) network over a broadband line;
a home applications gateway interface that is configured to communicate with the home applications gateway;
a twisted pair modem that is configured to communicate with home devices over home twisted pair cable;
a power line communications modem that is configured to communicate with home devices over home power lines; and
a coaxial cable modem that is configured to communicate with home devices over home coaxial cable.

6. A home applications gateway according to claim 5 wherein the home applications gateway and the residential gateway are contained in a common cabinet.

7. A home applications gateway according to claim 5 in combination with a broadband home security system that is responsive to home security sensors to provide signals to a home security monitoring center through the residential gateway via IP protocol.

8. A home applications gateway according to claim 7 wherein the broadband home security system is further configured to allow a phone call to be conducted through the residential gateway simultaneous with the signals that are provided to the home security monitoring center.

9. A home applications gateway according to claim 8 wherein the broadband home security system includes wireless communications backup via IP protocol and battery backup.

10. A home applications gateway according to claim 7 wherein the home applications gateway, the residential gateway and the broadband home security system are contained in a common cabinet.

11. A residential gateway comprising:
a broadband modem that is configured to communicate with an external network over a broadband line;
a twisted pair modem that is configured to communicate with home devices over home twisted pair cable;
a power line communications modem that is configured to communicate with home devices over home power lines;
a coaxial cable modem that is configured to communicate with home devices over home coaxial cable; and
a controller that is configured to coordinate communications between the external network and the home devices over the modems.

12. A residential gateway according to claim 11 further comprising:
an Ethernet switch that is configured to communicate with home devices over home Ethernet cable; and
an analog voice interface that is configured to provide voice communications with home devices;
wherein the controller is further configured to coordinate communications between the external network and the home devices over the Ethernet switch and the analog voice interface.

13. A residential gateway according to claim 11 in combination with a home applications gateway, the home applications gateway comprising:
a residential gateway interface that is configured to connect to the residential gateway; and
a Java Virtual Machine (JVM) that includes an Open Services Gateway initiative (OSGi) framework configured to execute OSGi Java applications that are downloaded and life cycle managed from a Web server through the residential gateway interface.

14. A residential gateway according to claim 13 wherein the OSGi Java applications include a video monitoring application that is configured to provide in-home and out-of-home access to home video cameras and video files captured by the home video cameras, at a Web page, wherein the home video cameras are connected to the twisted pair modem over home twisted pair cable, to the power line communications modem over the home power lines and/or to the coaxial cable modem over home coaxial cable.

15. A home security method comprising:
specifying home security parameters at a network provider Web page;
downloading a home security application package to a home applications gateway in the home through a residential gateway in the home that is connected to a Web server by an external network, in response to the specifying of home security parameters;
receiving notification of a security-triggering event from a home device that is connected to the residential gateway by a twisted pair, coaxial and/or power line cable and/or wirelessly;
storing security multimedia content from a home video camera that is connected to the residential gateway by a twisted pair, coaxial and/or power line cable and/or wirelessly at the application services gateway in response to the triggering event; and
enabling transmission of at least some of the stored multimedia content to an external home security monitoring center through the residential gateway and the external network, while simultaneously enabling voice communication over the external network through the residential gateway.

16. A method according to claim 15 further comprising:
transmitting messages to at least one device that is external to the home in response to the security-triggering event, through the residential gateway and the external network.

17. A method according to claim 16 wherein specifying home security parameters, downloading a home security application package, enabling transmission of at least some of the stored multimedia content, enabling voice communication and transmitting messages are performed through a broadband modem that is connected to the residential gateway.

18. A method according to claim 15 wherein downloading a home security application package comprises downloading an OSGi home security application to an OSGi framework that runs on a Java virtual Machine (JVM) in the application services gateway.

19. A method according to claim 15 wherein the home security parameters identify cameras for video capture and time parameters for video capture relative to a triggering event.

20. A method according to claim 15 further comprising:
automatically transmitting a notification message to at least one device connected to the external network through the residential gateway, in response to the triggering event.
